(19) United States
(12) Patent Application Publication
(10) Pub. No.: US 2023/0298077 A1
(43) Pub. Date: Sep. 21, 2023

(54) Software Management System

(71) Applicants: Yanni Koutmos, Torrington, CT (US); Alexander Koutmos, Torrington, CT (US)

(72) Inventors: Yanni Koutmos, Torrington, CT (US); Alexander Koutmos, Torrington, CT (US)

(21) Appl. No.: 18/318,155

(22) Filed: May 16, 2023

Related U.S. Application Data
(63) Continuation-in-part of application No. 17/522,235, filed on Nov. 9, 2021.

(51) Int. Cl. G06Q 30/04

(52) U.S. Cl. CPC G06Q 30/04

(57) ABSTRACT

A system that tracks the usage of materials used in a repair and collates that information into an accurate material estimation or invoice. The system utilizes material operation kits for common repair orders to increase organization and save on administrative costs. The system also utilizes material operation calculators to analyze the extent of damage on a vehicle and have that damage reflected in an invoice or estimation. The system additionally utilizes a material configuration to ensure that the correct discrete materials used on a repair are billed for accurately.

### CROSS-REFERENCE TO RELATED APPLICATIONS

This application is a continuation-in-part application of U.S. Non-Provisional patent application Ser. No. 17/522,235, filed Nov. 9, 2021 and titled “Software Management System.” The contents of the above-identified Application are relied upon and incorporated herein by reference in its entirety.

### FIELD OF THE INVENTION

The invention relates to a system for managing and tracking repairs performed in an auto body shop and the materials used in those repairs.

### BACKGROUND OF THE INVENTION

Currently, in the typical auto body shop, the cost of materials are calculated as a function of hours on an estimate. They are generally not based on an itemized counting of the actual materials used in a given repair. This is because it is usually difficult to obtain an accurate itemizing counting of the materials used in a repair. This is normally a difficult task considering technicians have to track the inventory of physical materials used, the volume of materials used, the percent of material used, the time a material is used, the length of the material used, and the mass of a material used. The plethora of different types of materials, the numerous technicians working in an auto body shop, and the time crunch that most technicians face can all potentially add to the difficulty of this very particular task. Tracking everything appropriately typically requires each and every technician to meticulously count and measure every item they use on a repair and then manually add the total materials used together to create an invoice for the repair. The time and labor required for each and every technician to calculate the materials and collaborate with other technicians to create an accurate itemized counting is typically too significant to be worth the effort for most auto body shops to deal with. As a result, many auto body shops simply default to calculating the cost of materials as a function of hours to avoid the hassle of tracking materials.

Tracking everything appropriately may even require hiring additional support staff to do this work for the technicians. This option could have its own problems though because it may prove to be difficult for the additional support staff to know how much of a given material is used when they are not the ones using the material in the repairs.

Additionally, as a result of being unable to create an accurate invoice for the materials used in a repair, auto body shops cannot receive proper reimbursement from insurance companies. Because of this, many auto body shops see deficits on the materials they use in a repair.

In light of these difficulties when operating an auto body shop, a new solution for tracking and managing all the materials used on a repair is required. What is desired then is an invention that tracks and manages all the materials used on a repair including the inventory of physical materials used, the volume of materials used, the percent of material used, the time a material is used, the length of the material used, and the mass of a material used and collates that data into a form that will automatically create an accurate material invoice for a given repair. Additionally, allowing this solution to be performed via a technician's smart phone device would improve the workflow of the entire auto body shop.

Further, some auto body shops engage in specific repairs on a frequent basis. These specific repairs incorporate similar amounts of material usage as they are typically based on vehicle body type or the operation being performed. As a result, it is desirable to be able to prepare accurate invoices for these specific and frequent repairs so that they can be billed appropriately. It is also desirable that an auto body shop can customize and optimize the material usage for these specific repairs based on how they operate as some auto body shops may use more or less of a given material for a specific repair.

Additionally, some auto body shops may have to provide estimates for the cost of materials for collision repair work on a vehicle. Providing accurate estimates for these costs allows an auto body shop to receive proper compensation for any collision repair work that they perform. What is desired then is the ability to provide precise estimates or invoices for all collision repair work completed on a vehicle in a way that is easily understood by the person or entity paying for the collision repair work, such as an insurance company.

### SUMMARY OF THE INVENTION

It is therefore an object of the invention to provide a system that tracks the usage of materials for a repair in a user-friendly and accurate manner.

Another object of the invention is to track the usage of different types of materials so inventory can be calculated effectively. Not all types of materials can be measured in physical units, i.e., 10 bolts. Therefore, the invention will track not only physical units, but also percent of material used, the volume of material used, the amount of time that a material is used, the length of a material used, and the mass of a material used, among other types of usage.

A further object of the invention is to create repair orders that several technicians can add to at the same time, allowing for a more fluid workflow on a repair order. Instead of a technician having to wait to add the materials they utilized to a singular device shared by multiple technicians, they can simply pull out their image recognition device, such as their smart phone, scan a repair order QR code tag, scan the material QR code tag, enter in the details related to the material they used, and then proceed to their next task. This will effectively eliminate the wait times that would be accrued if each technician had to enter the details of the material that they used onto one, shared device in an auto body shop.

An additional object of the invention is to create material QR code tags so that every material used on a repair order can be tracked accurately. If a new material is added to the inventory, all of the relevant details associated with the material will be associated with the material on the material QR code tag. Instead of having to manually enter in the specific material details for every single repair that uses a particular material, a technician will only have to scan the material QR code tag once with their image recognition device. By simply scanning the material QR code tag, all of the relevant information will be sent to the repair order and the technician will simply have to report how much of the material they used on a particular job. This will allow the technician to focus more on the repair order job at hand and less on the administrative tasks in tracking the materials. By doing this, the workflow of all technicians on a repair order will be significantly increased.

A further object of the invention is to accurately track the time spent working on a given repair order. When a technician scans a repair order QR code tag, a timer will automatically begin tracking the time a technician spends on the repair. When that technician either switches to a new repair order or ends their interactions with the original repair order, then that timer will stop accruing time to the repair order. Additionally, if there are two or more technicians working on a given repair order, the timer will keep track of each amount of time that they spend on the repair order separately, as well as the total amount of time that all technicians spend on the repair order.

Another object of the invention is to provide accurate invoices for specific and frequent repairs so they can be billed appropriately. When a user of the system knows that a technician has performed a specific repair that the auto body shop performs routinely, they can utilize the operation kit feature that generates all the materials used for that repair instead of having to input each material individually. As such, the user can save time on preparing the invoice. Further, as different auto body shops will have different material usages for a particular repair, each auto body shop can create, customize, and optimize within the operation kit feature. This allows each auto body shop to generate invoices that detail the materials used in a repair for their given shop, as each auto body shop will vary on the amounts of materials used based on their respective customs and practices.

A further object of the invention is to provide estimates and invoices for collision repair work so that they can be clearly understood by the person or entity paying for the collision repair work. When collision repair work is required, a user can create an estimate based on the vehicle body type and specific paint code of the car. The system allows the user to indicate which panels of the car require collision repair work. The system then provides a cost estimate based on the panels that have been indicated. Additionally, since some panels will require more work than others, the level to which more thorough collision repair work is needed can also be indicated in the system and will be reflected in the cost estimate.

### BRIEF DESCRIPTION OF THE DRAWINGS

So that the manner in which the above recited features can be understood in detail, a more particular description of the invention, briefly summarized above, may be had by reference to embodiments some of which are illustrated in the appended drawings. It is to be noted, however, that the appended drawings illustrate only typical embodiments and are therefore not to be considered limiting of its scope, for the invention may admit to other equally effective embodiments.

FIG. 1 depicts an overview block diagram of the system, in accordance with an embodiment of the invention.

FIG. 2 depicts an embodiment of the system creating a repair order QR code tag shown in FIG. 1.

FIG. 3 depicts an embodiment of the system creating a material QR code tag shown in FIG. 1.

FIG. 4 depicts an embodiment of the system updating the inventory of a material shown in FIG. 1.

FIG. 5 depicts an embodiment of the system automatically appending a scanned material QR code tag to a repair order shown in FIG. 1.

FIG. 6 depicts an embodiment of the system automatically creating a printable invoice for a repair order shown in FIG. 1.

FIG. 7 depicts an embodiment of the system automatically calculating various business analytics shown in FIG. 1.

FIG. 8 depicts an embodiment of the overview block diagram of the system shown in FIG. 1.

FIG. 9 depicts an embodiment of the system creating a repair order QR code tag shown in FIG. 8.

FIG. 10 depicts an embodiment of the system creating a material QR code tag shown in FIG. 8.

FIG. 11 depicts an embodiment of the system creating a material operation kit shown in FIG. 8.

FIG. 12 depicts an embodiment of the system creating a material calculator configuration shown in FIG. 8.

FIG. 13 depicts an embodiment of system accurately calculating the materials used for a repair order on a vehicle shown in FIG. 8.

### DETAILED DESCRIPTION OF THE INVENTION

It should be understood at the outset that, although exemplary embodiments are illustrated in the figures and described below, the principles of the present disclosure may be implemented using any number of techniques, whether currently known or not. The present disclosure should in no way be limited to the exemplary implementations and techniques illustrated in the drawings and described below.

The present invention relates to a management system that tracks the usage of materials used in a repair and collates that information into an accurate material invoice for a given repair. This system produces significantly more accurate and detailed invoices while also having a straightforward user interface. More specifically, the system involves scanning materials used in a repair order to generate this invoice. To accomplish this, the system utilizes a computer and software executing on that computer.

A computer is a device having one or more general or special purpose processors, memory, storage, and networking components. These networking components can be either wired or wireless.

In the commercial embodiment, the system operates as a web application, meaning that it is a computer program that uses a web browser to perform a particular function. In some embodiments, the system operates as a smart phone application. In other embodiments, the system works as a combined smart phone application and a web application. In further embodiments, the system works as a computer application. In even further embodiments, the system works as a combined web application, smart phone application, and computer application.

The system operates on a network. The network itself represents the communication pathways between the technicians and the online system. In some embodiments, the network is the Internet. In other embodiments, the network is a Local Area Network (LAN) that is not a part of the Internet.

The web server presents web pages that the technicians utilize to interact with the system. Technicians can utilize any device to access these web pages and provide data to the system. The web server may be a local server or a remote server

A Quick Response code (“QR code”) is a type of matrix barcode. A barcode is a machine-readable representation of numerals and characters. QR codes normally contain data for a locator, identifier, or tracker that points to a website or application. QR codes consist of black squares arranged in a square grid on a white background, which can be read by an image recognition device such as a smart phone. QR codes are processed using Reed-Solomon error correction until the image can be accurately interpreted by the image recognition device. The required data is then extracted from the patterns present in the QR code image.

In some embodiments of the invention, the system requires two-factor authentication before a technician or business administrator can interact with the system. In different embodiments, the system requires two-factor authentication every time a technician or business administrator scans a different repair order. In other embodiments, the system requires two-factor authentication every time any user, which is anyone who interacts with the system, authenticates with the system. In further embodiments, the system requires two-factor authentication before a business administrator closes out an existing repair order.

A manufacturer part number (MPN) is an identification number supplied by a manufacturer to identify specific products.

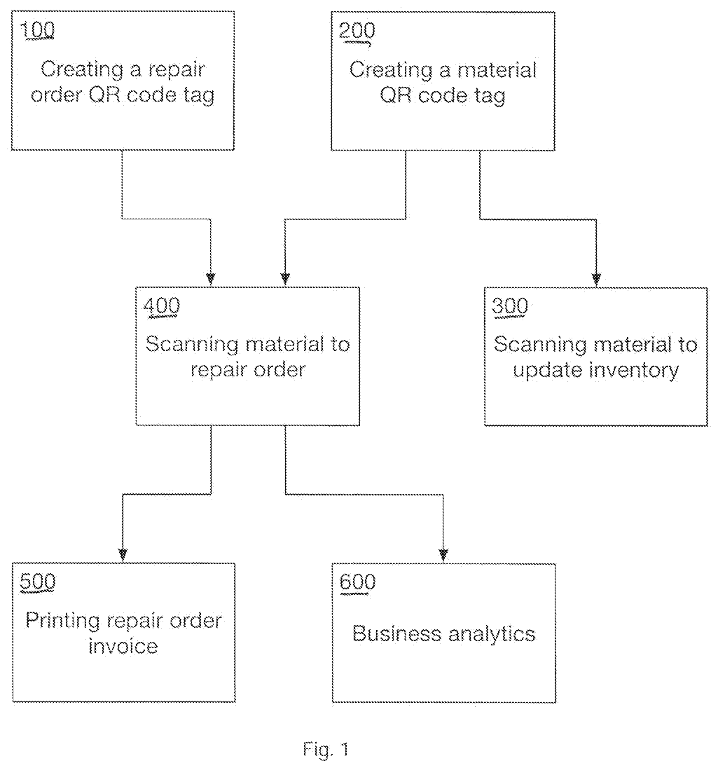

FIG. 1 depicts an overview block diagram of the system, in accordance with an embodiment of the invention.

The system creates a repair order QR code tag 100. In some embodiments, the repair order QR code tag are repair order tags or repair order identifiers, which can be, but are not limited to, a barcode, a MaxiCode, or a Data Matrix. In different embodiments, repair order QR code tags are referred to as repair orders.

The system creates a material QR code tag 200. In some embodiments, the material QR code tags are material code tags or material identifiers. In different embodiments, material QR code tags are referred to as materials. In some embodiments, the material identifiers can be, but are not limited to, a barcode, a MaxiCode, or a Data Matrix.

A technician scans material to a repair order 400. In some embodiments, the material is automatically appended to the repair order when it is scanned. In other embodiments, scanning the material to a repair order automatically prompts a technician to input how much of the material was used on the repair order. In different embodiments, the technician is a business administrator. In further embodiments, the technician is any user who interacts with the system. In different embodiments, there can be zero or more technicians, but there must be at least one business administrator. In other embodiments, there can be zero or more business administrators, but there must be at least one technician.

A technician scans material to update inventory 300. In some embodiments, a technician scanning the material to update the inventory is automatically prompted by the system to change other material details within the system. In other embodiments, the available stock of a material is automatically changed when a technician utilizes the material on a repair order. In different embodiments, the available stock of a material can be updated by suppliers within the system. In further embodiments, the system can automatically prompt a technician to update the inventory of a material.

In different embodiments, the technician scanning a material QR code tag to update inventory is a business administrator. In further embodiments, the technician is any user who interacts with the system.

The system prints repair order invoices 500. In different embodiments, the system can automatically generate an invoice once the last material QR code tag has been appended to a repair order for a type of repair. In other embodiments, the system can require a business administrator to print a repair order invoice. In some embodiments, the system can allow any user of the system to print a repair order invoice.

The system automatically generates business analytics 600. In different embodiments, the system does not automatically generate business analytics. In other embodiments, the system automatically makes suggestions regarding operational improvements based on the business analytics.

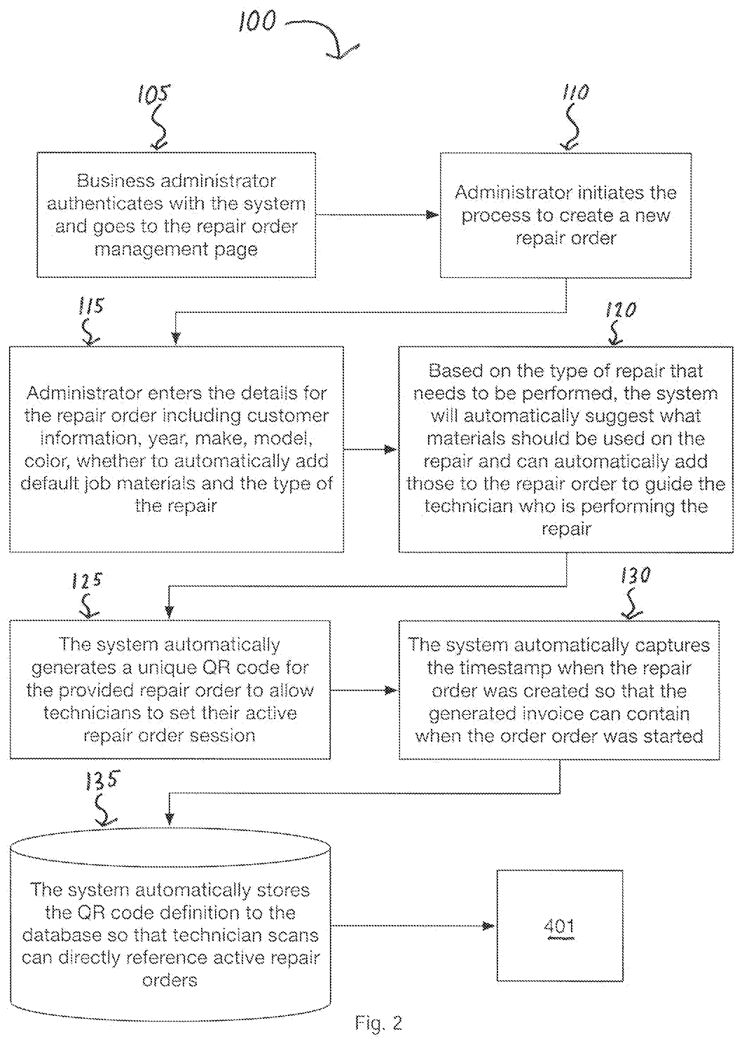

FIG. 2 depicts a system of generating a repair order QR code tag 100. This system utilizes a computer and software executing on the computer to allow a business administrator to authenticate with the system and go to the repair order management page 105. In the preferred embodiment, this authentication lasts for 30 days, allowing a business administrator to seamlessly engage with the system without having to authenticate themselves repeatedly. In other embodiments, this authentication can last from one hour to 90 days.

In some embodiments, a business administrator is a technician. In other embodiments, the business administrator is any user interacting with the system. In even further embodiments, there is only one business administrator. In different embodiments, there are at least two business administrators.

Administrator initiates the process to create a new repair order 110. In some embodiments, the system can automatically initiate the process to create a new repair order QR code tag. In other embodiments, a new repair order is automatically generated upon a customer inputting their information into the system. Instead of a business administrator having to enter in the general information related to the vehicle, the system will simply generate this based on the customer's information. A business administrator or technician can then review the automatically generated repair order to ensure that the details of the repair order are correct. In different embodiments, the system will retrieve this general information from a 3rd party system integration.

Administrator enters the details for the repair order including, but not limited to, the customer information, the year the vehicle was made, the make of the vehicle, the model of the vehicle, the color of the vehicle, whether to automatically add default job materials, the type of repair, and combinations thereof 115. In some embodiments, repair order details are repair order features. In further embodiments, the repair order features are selected for the repair order identifier.

In some embodiments, changing the repair order details of a pre-existing repair order will generate a new repair order QR code tag with a new QR code. In other embodiments, changing the repair order details of a pre-existing repair order will alter the repair order details without affecting the repair order QR code tag.

Based on the type of repair that needs to be performed, the system will automatically suggest what materials should be used on the repair and can automatically add those to the repair order to guide the technician who is performing the repair 120. In different embodiments, the system automatically suggests a list of recommended materials that can be used on a repair, allowing a technician to see the possible options of materials that can be used on a repair. In other embodiments, the system has a plurality of types of repairs. In some embodiments, the system associates a plurality of materials with each type of repair. In different embodiments, a technician, business administrator, or any other user who interacts with can select a type of repair. In some embodiments, when the user selects the type of repair, the system automatically generates materials associated with the type of repair. This eliminates the need for the user to add every single material for a repair based on their own memory and gives them a list of materials that they need to utilize in the repair. In some embodiments, the automatically generated materials associated with the type of repair can be removed by the user. In other embodiments, the automatically generated materials associated with the type of repair cannot be removed by the user. In some embodiments, the suggested material to use for that repair are derived from the year, make, and model of the vehicles as a result of different construction patterns.

The system automatically generates a unique QR code for the provided repair order to allow technicians to set their active repair order session 125.

The system automatically captures the timestamp when the repair order was created so that the generated invoice can contain when the repair order was started 130. In different embodiments, the scanning of a new repair order will create another timestamp for the first repair order so that the start and stop time of a technician working on the repair order can be recorded on the invoice.

The system automatically stores the QR code definition to the database so that technician scans can directly reference active repair orders 135. In other embodiments, the system automatically stores the repair order identifier definition to the database so that the technician scans can directly reference active repair orders. In different embodiments, the system automatically generates a unique repair order identifier for the repair order after the repair order features have been stored. This activates the billable project associated with the repair order QR code tag and allows scans of material QR code tag to be automatically appended to the billable project when the material QR code tag is scanned.

In some embodiments, the repair order can be deleted from the system by a business administrator. In other embodiments, the repair order can be deleted by a technician. In different embodiments, the repair order can be deleted by any user who interacts with the system.

In different embodiments, the system automatically prompts a warning to a business administrator that they are about to delete a repair order.

In some embodiments, deleted repair orders will be automatically removed from the system. In other embodiments, deleted repair orders will remain stored on the system for at least 7 days.

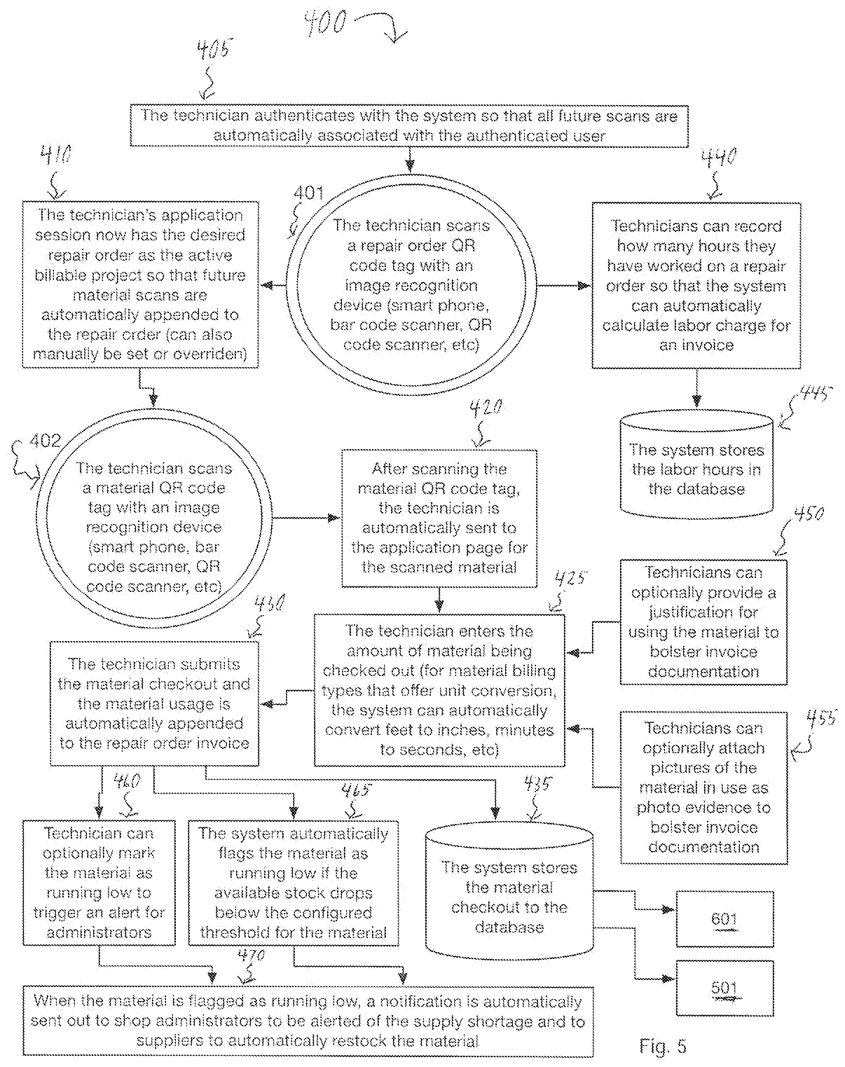

In FIG. 5, the technician scans the repair order QR code tag with an image recognition device, which can be, but is not limited to, a smart phone, bar code scanner, QR code scanner, personal computer with a webcam connected to it, a desktop computer with a webcam connected to it, a laptop computer with a webcam, a notebook with a webcam, or a kiosk 401.

Multiple technicians can scan material QR code tags into the unique billable project of a repair order simultaneously, allowing for a more seamless workflow environment. In some embodiments, a unique billable project is associated with a repair order identifier. In further embodiments, only one technician can work on a unique billable project associated with the repair order QR code tag. In different embodiments, only technicians selected by a business administrator can work on a billable project associated with the repair order QR code tag.

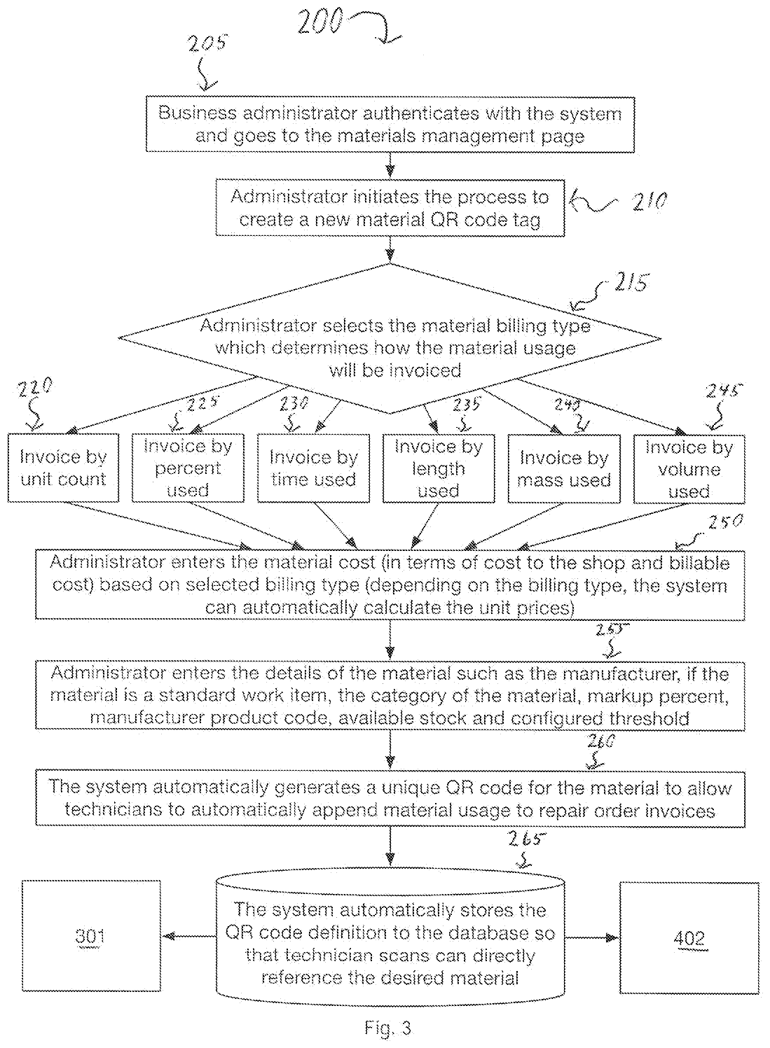

FIG. 3 depicts a system of generating a material QR code tag 200. The business administrator authenticates with the system and goes to the materials management page 205. In some embodiments, the business administrator is a technician. In other embodiments, the business administrator is any individual working with the system. In even further embodiments, there is only one business administrator. In different embodiments, there are at least two business administrators.

In the preferred embodiment, this authentication can last for 30 days, allowing the business administrator to seamlessly engage with the system without having to authenticate themselves repeatedly. In other embodiments, this authentication lasts at least 90 days.

The administrator initiates the process to create a new material QR code tag 210. In some embodiments, the material QR code tag is a material identifier, which can be, but is not limited to, a QR code, a bar code, a MaxiCode, or a Data Matrix. In different embodiments, material identifiers and repair order identifiers are referred to collectively as identifiers.

The administrator selects the material billing type which determines how the material usage will be invoiced 215. The material billing types include, but are not limited to, invoice by physical count 220, invoice by percent used 225, invoice by time used 230, invoice by length used 235, invoice by mass used 240, and invoice by volume used 245.

Administrator enters the material cost based on selected billing type 250 (depending on billing type, the system can automatically calculate unit prices). In some embodiments, the system can automatically calculate the unit prices using the material cost and the amount of a material used.

In different embodiments, the technician, business administrator, or any user who interacts with the system enters both a list price of a material and a wholesale price of a material when creating a material QR code tag. This will allow any user who interacts with the system to calculate the realized cost and the invoice cost. By entering both the list price and the wholesale price, any user who interacts with the system can quantify how much they are spending and invoicing on materials.

In some embodiments, the technician, business administrator, or any user who interacts with the system only enters the list price of a material. In other embodiments, the user only enters the wholesale price of a material. In different embodiments, the user does not enter either the list price of a material or the wholesale price of a material. In further embodiments, the list price of a material and the wholesale price of a material will automatically be associated with a material QR code tag. In even further embodiments, the list price of a material and wholesale price of a material can be collected from a database of material costs or a third-party system integration.

Administrator enters the details of the material such as the manufacturer of the material, if the material is a standard work item, the category of the material, the markup percent of the material, the manufacturer product code, the available stock, configured threshold, and combinations thereof 255. In some embodiments, the unit prices may be collected from a database of material costs or a third-party system integration. In different embodiments, material details can include any details that would be considered by a person of ordinary skill in the art.

In some embodiments, any material can be a standard work item. In other embodiments, only certain materials can be a standard work item. In other embodiments, a business administrator selects which materials are a standard work item.

In some embodiments, the configured threshold is automatically compared to the available stock. If the available stock is greater than or equal to the configured threshold, then the material scan tag will not be flagged for restock. If the available stock is less than the configured threshold, then the material scan tag will be flagged for restock.

In some embodiments, the material features that a business administrator can select for a material QR code tag include, but are not limited to, material billing type, material cost, material details, and combinations thereof. In further embodiments, the material features that a business administrator can select for a material identifier include, but are not limited to, material billing type, material cost, and material details, and combinations thereof.

The system automatically generates a unique QR code for the material to allow technicians to automatically append material usage to repair order invoices 260.

The system automatically stores the QR code definition to the database so that technician scans can directly reference the desired material 265. In other embodiments, the system automatically stores the material identifier definition to the database so that the technician scans can directly reference the desired material and the material features. In different embodiments, the system automatically generates a unique material identifier for the material when the material features have been stored.

In some embodiments, repair order features and material features are referred to collectively as features. In different embodiments, a plurality of features can be associated with an identifier. In other embodiments, a technician, business administrator, or any other user who interacts with the system can select features for an identifier. In some embodiments, an identifier is automatically generated with the selected features.

In some embodiments, the material can be deleted from the system by the administrator. In other embodiments, the material can be deleted by a technician. In different embodiments, the repair order can be deleted by any user who interacts with the system.

In different embodiments, the system automatically prompts a warning to a business administrator that they are about to delete a material.

In some embodiments, the system automatically prints out the material QR code tag when the system generates the unique QR code. In other embodiments, the system will notify a technician, a business administrator, or a user who interacts with the system that the material QR code tag has not been printed. In different embodiments, the system will automatically compile all the material QR code tags stored in the database into a document so that all the material QR code tags associated with the auto body repair shop can be bulk printed. In further embodiments, the system can only print material QR code tags individually. In even further embodiments, the system will automatically compile all the material QR code tags selected by a technician into a document so these selected material QR code tags can be bulk printed. In some embodiments, a technician can be any user who interacts with the system.

In different embodiments, technicians, business administrators, or any user who interacts with the system can create material bundles. Material bundles are groupings of multiple different materials that are used on particular types of repairs. When a material bundle is created, it will automatically generate a unique material bundle QR code tag that can be scanned. Upon scanning this material bundle QR code tag, all the materials associated with the material bundle QR code tag will be appended to the unique billable project of a repair order. For example, one scan of a material bundle may include several abrasives, body filler, primer, blocking paper, etc. This will allow a technician to only have to scan one material bundle QR code tag for a repair order instead of having to scan multiple individual material QR code tags. In some embodiments, the material bundle QR code tags are material bundle code tags or material bundle identifiers. In different embodiments, material bundle QR code tags are referred to as material bundles. In some embodiments, the material bundle identifiers can be, but are not limited to, a barcode, a MaxiCode, or a Data Matrix.

In FIG. 5, the technician scans a material QR code tag with an image recognition device, which can be, but is not limited to, a smart phone, bar code scanner, QR code scanner, personal computer with a webcam connected to it, a desktop computer with a webcam connected to it, a laptop computer with a webcam, a notebook with a webcam, or a kiosk 402.

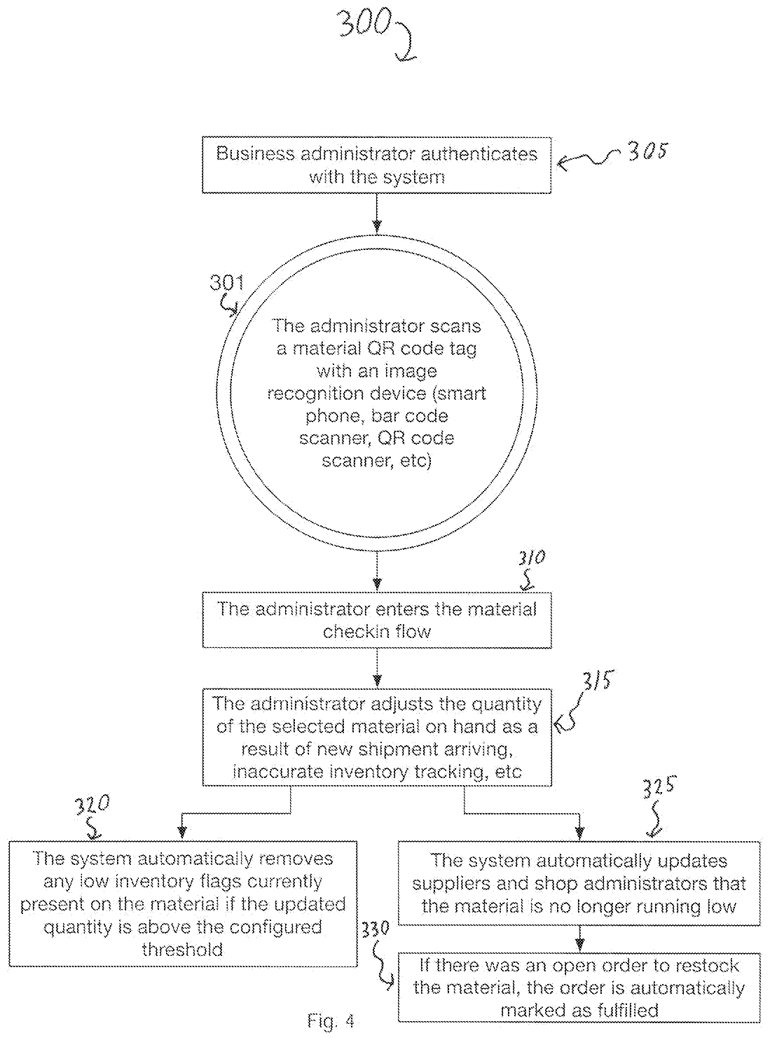

In FIG. 4, the business administrator scans a material QR code tag with an image recognition which can be, but is not limited to, a smart phone, bar code scanner, QR code scanner, personal computer with a webcam connected to it, a desktop computer with a webcam connected to it, a laptop computer with a webcam, a notebook with a webcam, or a kiosk 301.

FIG. 4 depicts a system for updating a material QR code tag 300. This system utilizes a computer and software executing on the computer to allow a business administrator to authenticate with the system 305. In the preferred embodiment, this authentication can last for 30 days, allowing a business administrator to seamlessly engage with the system without having to authenticate themselves repeatedly. In other embodiments, this authentication can last from one hour to 90 days.

In some embodiments, a business administrator is a technician. In other embodiments, a business administrator is any user working with the system. In even further embodiments, there is only one business administrator. In different embodiments, there are at least two business administrators.

The administrator scans a material QR code tag with an image recognition which can be, but is not limited to, a smart phone, bar code scanner, QR code scanner, personal computer with a webcam connected to it, a desktop computer with a webcam connected to it, a laptop computer with a webcam, a notebook with a webcam, or a kiosk 301.

The administrator enters the material checkin flow 310.

The administrator adjusts the quantity of the selected material on hand as a result of new shipments arriving or inaccurate inventory tracking, among other events that can cause the quantity of selected material to no longer be correct 315.

The system automatically removes any low inventory flags currently present on the material if the updated quantity is above its configured threshold 320. In other embodiments, the system automatically removes any low inventory flag if the available stock of the material is greater than or equal to the configured threshold.

The system automatically updates suppliers and shop administrators that the material is no longer running low 325. In other embodiments, the system does not automatically update suppliers and shops administrators that the material is no longer running low. In different embodiments, the system can automatically prompt a business administrator with a reminder to contact the suppliers and shop administrators that the material is no longer running low.

If there was an open order to restock the material, the order is automatically marked as fulfilled 330.

FIG. 5 depicts a system of scanning a material to a repair order 400. This system utilizes a computer and software executing on that computer to allow a technician to authenticate themselves with the system so that all future scans are automatically associated with the authenticated user 405.

In the preferred embodiment, this authentication will last for 30 days, allowing a technician to seamlessly engage with the system without having to authenticate themselves repeatedly. In other embodiments, this authentication will last from one hour to 90 days. In some embodiments, the technician can be a business administrator. In different embodiments, the technician can be any user who interacts with the system.

In some embodiments, there is only one technician. In different embodiments, there are at least two technicians. In other embodiments, there can be zero technicians and at least one administrator.

In different embodiments, scanning the repair order identifier automatically initiates the unique billable project associated with the repair order identifier. In some embodiments, the unique billable project can have a plurality of material identifiers appended to it.

The technician scans a repair order QR code tag with an image recognition device, which can be, but is not limited to, a smart phone, bar code scanner, QR code scanner, personal computer with a webcam connected to it, a desktop computer with a webcam connected to it, a laptop computer with a webcam, a notebook with a webcam, or a kiosk 401. In other embodiments, there can be multiple technicians working on the same repair order QR code tag at once.

Technicians can record how many hours they have worked on a repair order so that the system can automatically calculate the labor charge for an invoice 440.

The system stores these labor hours to the database 445. In some embodiments, a technician can manually record the amount of time they work on a repair order. In other embodiments, the time is measured in hours, minutes, and seconds.

In different embodiments, the scanning of the repair order QR code tag automatically starts a timer that ends upon either a technician completing the repair listed on the repair order QR code tag or when a technician scans a new repair order QR code tag. If a technician scans a new repair order QR code tag, then the time interval a technician has already spent on the first repair order QR code tag will be automatically recorded and stored in a database. In other embodiments, the labor hours can automatically be tracked by the system by having the technician start a timer in the application, and only when the timer is terminated, is the labor time added to the selected repair order.

In further embodiments, the scanning of the repair order QR code tag automatically starts a timer that automatically ends and calculates a time interval upon a specified time within in the system. This specified time can be any time chosen by a business administrator, technician, or any user who interacts with the system. In these embodiments, the specified time can be, but is not limited to, lunch time, break time, or closing time. For example, if closing time is at 5:00 P.M. and a technician scans a repair order QR code tag at 4:30 P.M., then the maximum amount of time that can be accrued on the time interval is 30 minutes. If the time reaches 5:00 P.M. and the technician is still working on the repair order, then the timer will automatically end and the accrued time interval will be calculated and stored into a database. This will help keep the total time intervals accrued on a repair order accurate without a technician needing to remember to stop the timer.

In different embodiments, the scanning of the repair order QR code tag automatically starts a timer that automatically ends and calculates a time interval upon not interacting with the repair order QR code tag after a set amount of time has passed. This set amount of time can be any amount of time chosen by a business administrator, technician, or any user who interacts with the system. For example, if the repair order QR code tag has not been interacted with for 15 minutes, then the timer will automatically end and the accrued time interval will be calculated and stored into a database.

In some embodiments, the scanning of the repair order QR code tag automatically starts a timer that automatically ends and calculates a time interval upon a technician inputting the amount of materials used on the last material to be used on a type of repair. This time interval is then stored into a database.

In further embodiments, the scanning of the repair order QR code tag automatically starts a timer that that automatically calculates a time interval upon a technician inputting the amount of materials used on a material with particular material details. For example, if the material is paint and the paint must dry before the technician proceeds with the repair order, then the system will automatically calculate the time interval based on the time the amount of paint is input into the system rather than including the time that the paint would need to dry. This time interval is then stored into a database.

In other embodiments, a technician can remove their association with a repair order QR code tag by scanning a new repair order QR code tag, allowing for increased workflow from one repair order to the next. A technician will be able to add material QR code tags to this new repair order QR code tag. This process of removing a repair order QR code tag by scanning a new repair order QR code tag can be done at the technician's discretion.

In some embodiments, if a technician has scanned a first repair order QR code tag and they desire to switch over to a second repair order QR code tag, they simply have to scan the second repair order QR code tag and all their subsequent material scans will then be appended to the second repair order QR code tag's unique billable project instead of the first. Thus, by scanning a second repair order QR code tag, they automatically initiate the second repair order QR code tag's unique billable project as well as automatically disassociate their subsequent materials scans from being appended to the first repair order QR code tag's unique billable project. In other embodiments, scanning a second repair order identifier automatically initiates a second unique billable project. In further embodiments, the scanning of a second repair order identifier automatically dissociates future scans of material identifiers from the first unique billable project. In some embodiments, when a repair order is closed, material scans can no longer be made against the repair order and any technicians or administrators that have that repair order as their active session will have that repair order automatically cleared from their session and they must select a new repair order.

In different embodiments, a technician can work on one repair order QR code tag at a time. In other embodiments, a technician can work on multiple repair order QR code tags at the same time.

In further embodiments, the system will have a list of all repair orders for a technician to select. Once the repair order is selected by the technician, all the technician's scans of material QR codes will automatically be appended to that repair order's unique billable project, allowing for alternative avenues for changing repair orders outside of scanning a new repair order QR code tag. In different embodiments, a technician can select a different repair order at any time without having to scan the repair order QR code tag.

In some embodiments, the time intervals by different technicians working on a single repair order will be tracked individually on a per technician basis. In other embodiments, the total amount of all time intervals on a single repair order QR code tag by each technician who worked on the repair order will be tracked.

In different embodiments, the total time worked by each technician can be automatically stored into a separate database for payroll purposes. In further embodiments, the total hours worked by each technician can be automatically exported to the payroll management system.

In some embodiments, the plurality of time intervals accrued for a repair order will be appended to the unique billable project associated with that repair order.

In different embodiments, the system has set time interval ranges for different types of repairs. In further embodiments, the system can automatically flag a repair order if the time intervals that a technician takes to complete a type of repair fall outside of the set time interval ranges for that type of repair. A business administrator can then review the flagged repair order to determine whether the time intervals that a technician takes are appropriate or not.

The technician's application session now has the desired repair order as the active billable project so that future material scans are automatically appended to the repair order (can also manually be set or overridden) 410. Each repair order is associated with a unique billable project. In other embodiments, each repair order is associated with at least two active billable projects. In different embodiments, the unique billable project associated with a repair order identifier can have materials appended to it upon scanning their material identifiers.

The technician scans a material QR code tag with an image recognition device 402.

After scanning the material QR code tag, the technician is automatically sent to the application page for the scanned material 420. In some embodiments, scanning the material QR code tag can automatically fill in the amount of material being checked out based on the type of repair. A technician can then review the amount of material being checked out and make changes as needed.

The technician enters the amount of material being checked out (for material billing types that offer unit conversion, the system can automatically convert feet to inches, minutes to seconds, etc.) 425. In some embodiments, the material billing type includes, but is not limited to, the physical count of the material used, the percent of material used, the time that a material is used, the length of a material used, the mass of a material used, and the volume of a material used. In other embodiments, the system can automatically convert all units related to time, mass, length, area, volume. In further embodiments, the system can automatically convert units into the standard industry unit of measurement, such as a drum container, which has a volume equal to 55 US gallons.

The technician can optionally provide a justification for using the material to bolster invoice documentation 450. In this embodiment of the invention, the technician will be able to, among other things, explain why they used a certain amount of a given material. In some embodiments, the system can automatically prompt the technician to write a justification.

In other embodiments, the system has set ranges for the amount of material normally used on a type of repair. The system will automatically prompt a technician to write a justification if the technician used an amount of material that falls outside of the set ranges for the amount of materials normally used on a type of repair. In even further embodiments, the system will automatically alert a business administrator if a technician has used an amount of materials outside the set ranges. This alert will allow the business administrator to immediately view the justification given by the technician and automatically request more of a justification from the technician if the business administrator believes that the justification is insufficient.

In different embodiments, a technician will not have to provide a justification for using the material to bolster invoice documentation.

The technician can optionally attach pictures of the materials in use as photo evidence to bolster invoice documentation 455. Attaching photos adds weight to the strength of the invoice because the images will demonstrate the need for the amount of materials used.

In further embodiments, the system will automatically notify a technician to attach photos based on the total amount of time spent on a repair order QR code tag. The total amount of time spent on a repair order QR code tag will be automatically calculated using the time intervals accrued by each technician while they work on a repair order QR code tag. In some embodiments, the system will automatically notify a business administrator that photos have been attached. This notification will allow the business administrator to immediately view the photos and vet them for clarity, quality, and visibility, among other things. The business administrator will be simultaneously prompted to approve or disapprove of the photos. If the business administrator approves of the photos, they will automatically be appended to the invoice documentation. If the business administrator disapproves of the photos, the system will automatically notify the technician to retake the photos.

The technician submits the material checkout and the material usage is automatically appended to the repair order invoice 430. In some embodiments, the material usage can increase or decrease the total amount of the material that is inventory. The measure of the total amount of a material in inventory is the available stock.

In some embodiments, the available stock can be measured in identical units as the amount of materials used. This includes, but is not limited to, the physical count of the material used, the percent of material used, the time of the material used, the length of a material used, the mass of a material used, and the volume of a material used. For example, if the amount of materials used is measured by physical count, i.e., 50 Steel Flanged Hex Head Screws, then the available stock will also be measured by physical count, i.e., 250 Steel Flanged Hex Head Screws.

Technician can optionally mark material as running low to trigger an alert for administrators 460.

The system automatically flags the material as low if the available stock drops below a configured threshold for the material 465. In some embodiments, the system does not flag the material as low if the available stock drops below a configured threshold for the material. In different embodiments, flagging is performed manually by a business administrator, technician, or any other user who interacts with the system.

When a material is flagged as running low, a notification is automatically sent out to shop administrators to be alerted of the supply shortage and to suppliers to restock the material 470. In some embodiments, the configured threshold can be based on the percent amount of the available stock. In other embodiments, the configured threshold can consider the market availability of the material before flagging the available stock as running low. If there is a surplus of a given material available on the market, then the material will be flagged later because suppliers will more easily be able to restock the material. If there is a deficiency of a given material available on the market, then the material will be flagged earlier because suppliers will have more trouble restocking the material.

When the material QR code tag is appended to the repair order invoice, the system will store the material checkout to the database 435. In some embodiments, there is only one database for the system. In other embodiments, there are at least two databases for the system. In different embodiments, each supplier will have at least one database for the system. In some embodiments, the supplier's database will allow the supplier to view the inventory of materials in an auto body shop and fulfill orders for the auto body shop, among other uses.

In different embodiments, the system automatically associates the material identifier with the repair order identifier in that the material identifier will be appended to the repair order invoice. In further embodiments, the material identifier has a material usage history that automatically updates when the material is used. This will allow a technician, business administrator, or user of the system to see information related to the material identifier such as when the material was used, what repair order was the material used on, and what technician utilized the material.

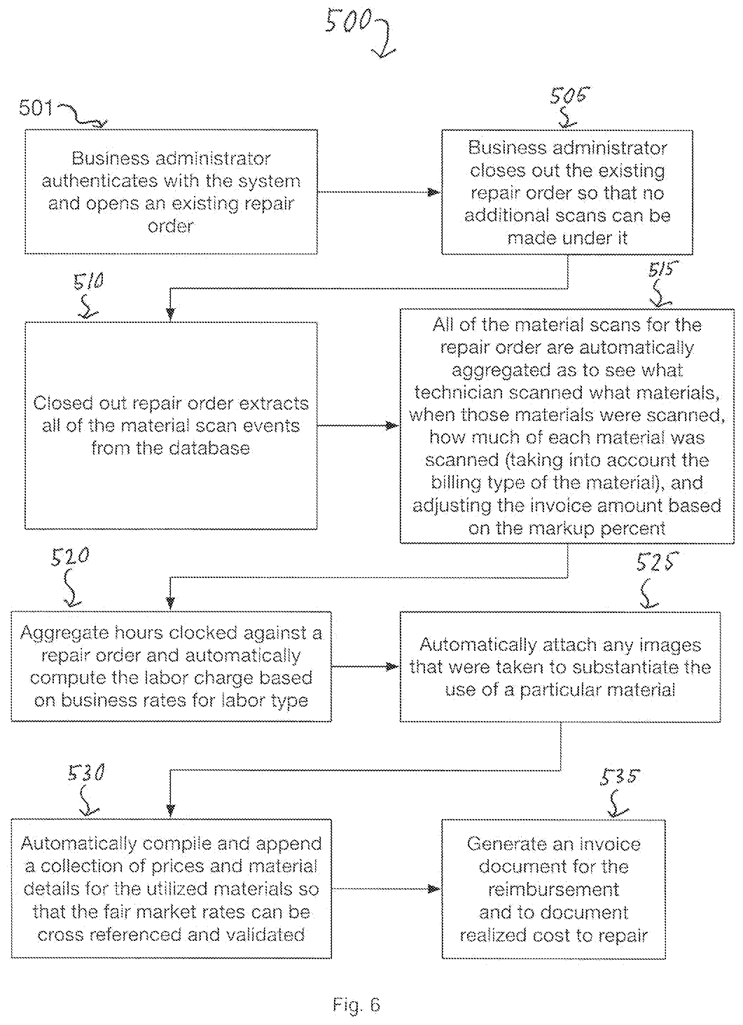

In FIG. 6, the system utilizes a computer and software executing on the computer to allow a business administrator to authenticate with the system and opens an existing repair order 501.

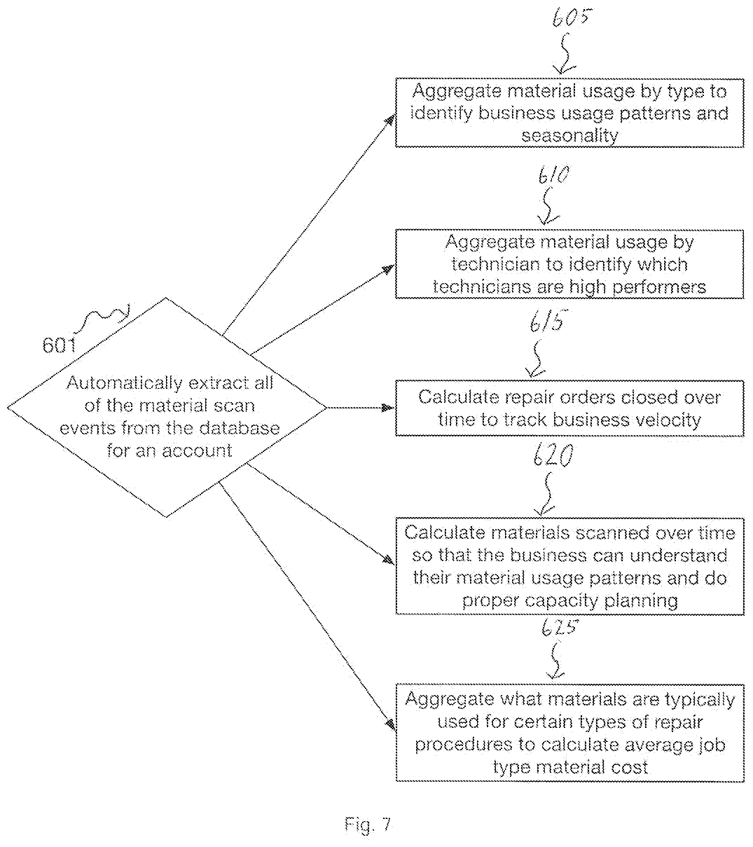

In FIG. 7, the system utilizes a computer and software executing on that computer that automatically extracts all the data from all of the material scan events from the database for an account 601.

FIG. 6 depicts a system of generating a repair order invoice 500. The system utilizes a computer and software executing on the computer to allow a business administrator to authenticate with the system and opens an existing repair order 501. In some embodiments, the business administrator is a technician. In other embodiments, the business administrator is any user working with the system. In even further embodiments, there is only one business administrator. In different embodiments, there are at least two business administrators.

In the preferred embodiment, the business administrator's authentication can last for 30 days, allowing the business administrator to seamlessly engage with the system without having to authenticate themselves repeatedly. In other embodiments, this authentication can last from one hour to 90 days.

In other embodiments, the existing repair order's invoice will not open unless there are material identifiers associated with it. In different embodiments, the existing repair order's invoice will open when there are no material identifiers associated with it.

The business administrator closes out a repair order so that not additional scans can be made under it 505. In different embodiments, additional scans can be made under the repair order after the business administrator closes out a repair order.

In other embodiments, there must be at least one material QR code tag scanned to a unique billable project that is associated with a repair order QR code tag before it can be closed out. In different embodiments, there must be at least one material identifier scanned to a unique billable project that is associated with a repair order identifier before it can be closed out.

The closed out repair order extracts all of the material scan events from the database 510. In some embodiments, any material QR code tag that has been flagged cannot be extracted from the database. In other embodiments, the system can automatically inform the business administrator that there are flagged material QR code tags extracted from the database. In different embodiments, the system can automatically stop the extraction from occurring until the administrator reviews and removes the flagged material QR code tags. In further embodiments, the system can automatically open each of the flagged QR code tags. This will allow the administrator to see the available stock of flagged QR code tags and give notice to suppliers that certain materials have an available stock below the configured threshold.

In different embodiments, the closed out repair order can be reopened. In other embodiments, the closed out repair order can have the repair order details updated. In some embodiments, the closed out repair order cannot be updated. In other embodiments, a business administrator can reopen the repair order. In further embodiments, any user who interacts with the system, including business administrators and technicians, can reopen the repair order.

In different embodiments, a repair order that is reopened will be automatically flagged by the system. In other embodiments, a repair order that is reopened will not be flagged by the system.

In some embodiments, a closed out repair order can have material scan events removed from the repair order. In further embodiments, a closed out repair order cannot have material scan events removed from the repair order.

All of the material scans for a repair order are automatically aggregated as to see what technician scanned what materials, when those materials were scanned, how much of each material was scanned (taking into account the billing type of the material), and adjusting the invoice amount based on the markup percent 515. In some embodiments, if the same technician is routinely using too little or too much of a material, the system can flag the technician to a business administrator. This will be used for, among other purposes that are obvious to one of ordinary skill in the art, teaching a technician the proper methods of different types of repairs by guiding how much of a particular material they should use on these repairs.

In other embodiments, if certain materials were out of order for a particular type of repair, the system will flag a technician who used the materials out of order. This will be used for, among other purposes that are obvious to one of ordinary skill in the art, teaching a technician the proper methods of different types of repairs by guiding them on when they are supposed to use a particular material.

The system aggregates hours clocked against a repair order and automatically computes the labor charged based on business rates for the labor type 520. In some embodiments, the labor charge rate can be manually determined by a business administrator. In different embodiments, the labor charge rate can be manually determined by a technician or any user who interacts with the system. In other embodiments, the labor charge rate will be based on industry standards. In even further embodiments, the labor charge rate can be based on the type of repair.

The system automatically attaches any images that were taken to substantiate the use of a particular material 525. In some embodiments, a business administrator can select the images to be displayed on the invoice document. In other embodiments, a business administrator cannot select the images to be displayed on the invoice document. In even further embodiments, the system will automatically attach all images associated with the repair order.

The system automatically compiles and appends a collection of prices and material details for the utilized materials so that the fair market rates can be cross referenced and validated 530. In some embodiments, the system does not automatically compile and append a collection of prices and material details for the utilized materials so the fair market rates can be cross referenced and validated.

The system generates an invoice for reimbursement and to document realized cost to repair 535. In different embodiments, the system automatically collates the unique billable project of a repair order into a form. In some embodiments, the system automatically generates an invoice document with the form. In other embodiments, the system will generate this invoice automatically. In different embodiments, the business administrator reviews the invoice before the invoice is generated. In further embodiments, other factors will be taken into consideration such as the expenses of acquiring particular materials for a type of repair.

FIG. 7 depicts a system of generating a repair order invoice 600. This system utilizes a computer and software executing on that computer that automatically extracts all the data from all of the material scan events from the database for an account 601. In different embodiments, the system will automatically extract all the data from selected material scan events from the database for an account. In other embodiments, the system does not automatically extract all the data from all of the material scan events from the database for an account. In some embodiments, the system comprises of a plurality of repair order identifiers. In further embodiments, the system automatically extracts all the data from the plurality of repair order identifiers from the database for an account. In most embodiments, the account will generate a variety of business analytics including, but not limited to, aggregate material usage by type to identify business usage patterns and seasonality, aggregate material usage by technician to identify which technicians are high performers, the repair orders closed over time to track business velocity, and the materials scanned over time so that the business can understand their material usage patterns and do proper capacity planning.

In some embodiments, a business administrator can initiate the system to automatically extract all the data for an account. In other embodiments, a technician can initiate the system to automatically extract all the data for an account. In further embodiments, any user who interacts with the system can initiate the system to automatically extract all the data for an account.

The system aggregates material usage by type to identify business usage patterns and seasonality 605. In other embodiments, the system will automatically send this material usage data to suppliers. In further embodiments, the system will automatically update the material usage data sent to suppliers. In some embodiments, the system does not aggregate material usage by type to identify business usage patterns and seasonality.

The system aggregates material usage by technician to identify which technicians are high performers 610. In different embodiments, the system aggregates material usage by a group of technicians to identify which groups are high performers. This will allow a business administrator to determine the most effective grouping of technicians. In some embodiments, the system does not aggregate material usage by technician to identify which users are high performers.

In other embodiments, the system automatically aggregates other business analytics related to material usage that would be useful to one of ordinary skill in the art.

The system calculates repair orders closed over time to track business velocity 615. In some embodiments, the system does not calculate repair orders closed over time to track business velocity.

The system calculates materials scanned over time so that the business can understand their material usage patterns and do proper capacity planning 620. In further embodiments, the system will automatically send suppliers this information, allowing them to more precisely supply materials. In some embodiments, the system does not make determinations on material usage patterns.

The system aggregates what materials are typically used for certain types of repair procedures to calculate average job type material cost 625. In some embodiments, the system does not aggregate what materials are typically used for certain types of repair procedures to calculate average job type material cost. In other embodiments, the system will factor in current market costs for materials when calculating average job type material cost.

In other embodiments, the system automatically calculates other business analytics that would be useful to one of ordinary skill in the art.

In even further embodiments, the system automatically makes suggestions that provide insight on operational improvements that can be made based on the business analytics. These suggestions can be based on the entire database of all auto body repair shops utilizing the system. This will allow for the operation and management of an auto body repair shop to be optimized and will also create a community of technicians, business administrators, and other users of the system that can share beneficial strategies with each other.

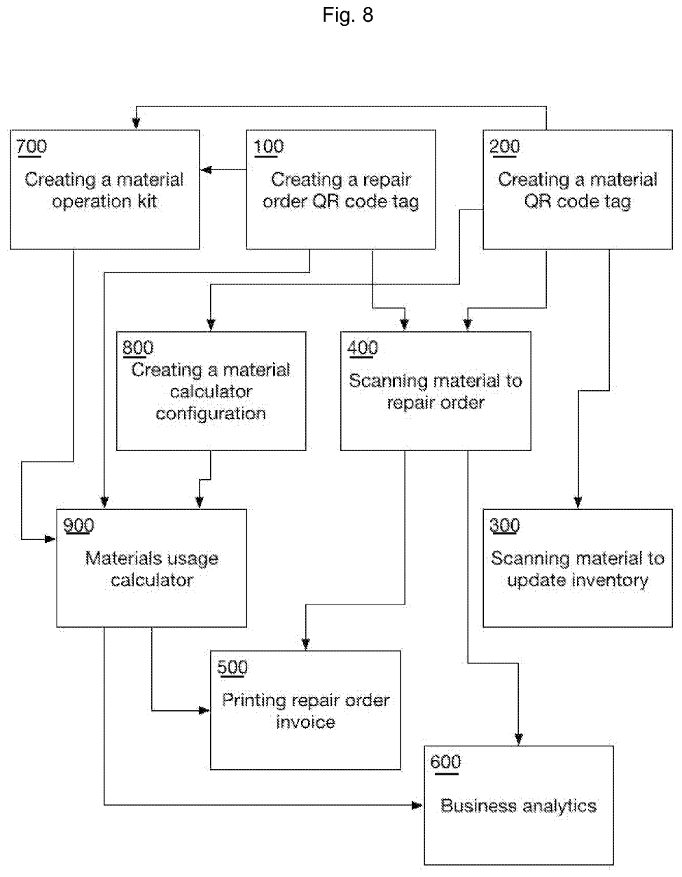

FIG. 8 depicts an embodiment of the overview block diagram of the system shown in FIG. 1.

In addition to creating a repair order QR code tag 100, creating a material QR code tag 200, scanning material to update inventory 300, scanning material to repair order 400, printing repair order invoice 500, and business analytics 600, all of which were a part of the overview block diagram shown in FIG. 1, FIG. 8 also includes creating a material operation kit 700, creating a material calculator configuration 800, and creating a material usage calculator 900.

The system creates a material operation kit 700. In some embodiments, a user, such as a business administrator or a technician, creates a material operation kit that incorporates the specific materials that are used for a particular repair. This allows the user to generate custom material operation kits for their auto body shop, ensuring that the accurate invoices are generated because these material operation kits will reflect the idiosyncrasies of their auto body shop. This is important as the methods and practices of auto body shops can greatly vary. For example, the amount of materials used by one auto body shop for a car collision repair may be vastly different at another auto body shop for the same car collision repair.

In addition, creating material operation kits for particular repairs allows the user to add all the materials they used to an invoice at once instead of having to individually add each material to the invoice. The material operation kit contains all the materials used for a particular repair. This means that when the particular repair is performed again by the auto body shop, instead of having to individually add each material for the repair, the user can simply utilize the material operation kit previously created for the previous repair. By doing this, the materials for that repair automatically populate and are added to an invoice. This eliminates the need for the user to individually input each material, thus, increasing the efficiency of the system by saving time for the user.

In other embodiments, the system has a plurality of material operation kits that the user can select.

The system creates a material calculator configuration 800. In some embodiments, the system modifies an existing material calculator configuration. The material calculator configuration allows the system to assign discrete materials that are in a business' or auto body shop inventory from abstract materials that are detailed in the system. Discrete materials are any of the materials that an auto body shop actually utilizes in their shop. Abstract materials are general categories of materials commonly utilized within the auto body shop industry. By associating discrete materials with abstract materials, the system can generate accurate estimations and invoices as it utilizes accurate costs of a discrete material used by the auto body shop as opposed to a generalized price for an abstract material.

The material usage calculator of the system 900. The material usage calculator is a tool within the system to provide costs for different types of repair jobs based on the severity of damage that occurred to particular components of the vehicle. The costs of the material usage calculator are the costs of the materials needed to complete the repair. Acting on a repair order, the system uses the material usage calculator to identify where and the extent to which a repair must be performed. Based on the extent of the damage, cost of materials necessary to repair the damage, and other factors, the system calculates the costs associated with the repair order and generates an invoice or estimation. The material usage calculator utilizes the material operation kits and the material calculator configuration to generate estimations or invoices. In this way, the materials usage calculator, otherwise known as the materials calculator in the specification, is associated with the material operation kits and materials calculator configuration.

The material usage calculator generates the invoice or estimation based on the extent of damage to particular components of the vehicle because the extent of damage can vary greatly from component to component. If a certain component of the vehicle is only slightly damaged, this will require fewer materials and less work than that same component that is significantly damaged. The material usage calculator allows this concept to be applied to the entirety of the vehicle, enabling auto body shops to particularly specify the amount of materials required for each component of the vehicle, thus allowing for accurate invoices and estimations to be generated. If some components of the vehicle need relatively little work and other components need a significant amount of work, this labor time is reflected in the estimation as well. The extent of damage to a particular component is associated with an invoice or estimation by utilizing a diagram where the extent of damage can be indicated.

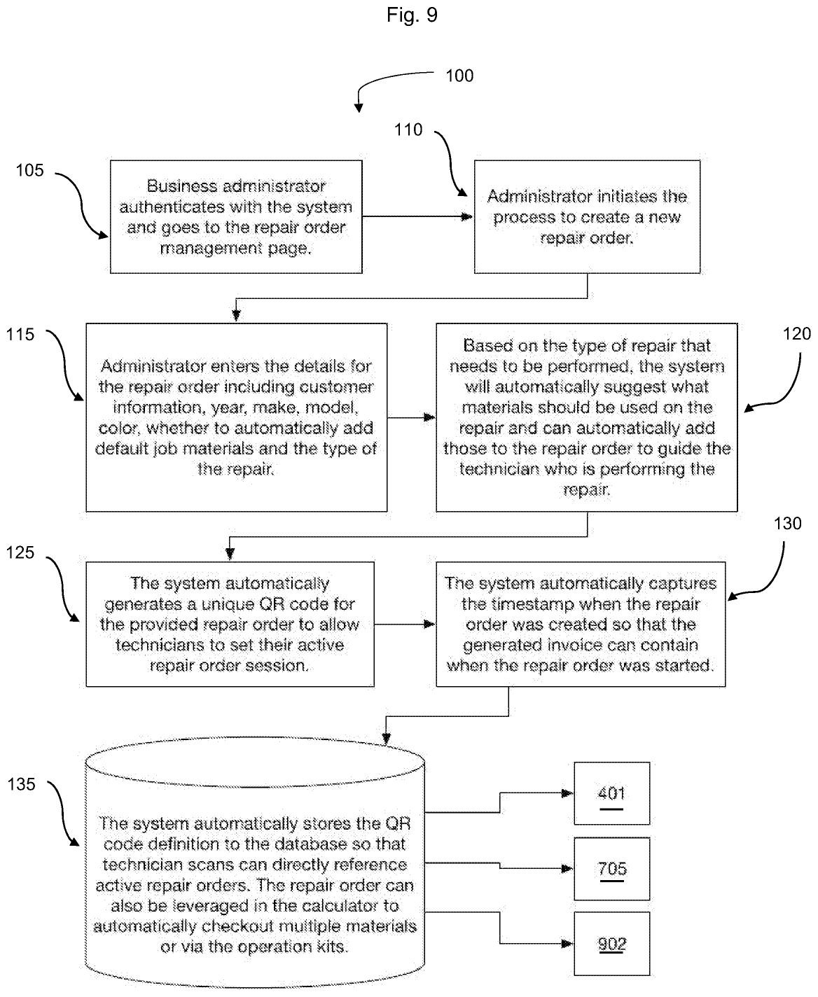

FIG. 9 depicts an embodiment of the system creating a repair order QR code tag shown in FIG. 8. FIG. 9 is another embodiment of FIG. 2. However, the system as shown in FIG. 9 additionally allows for the creation of identifiers, such as QR codes, to be automatically generated for operation kits 702. Further, FIG. 9 illustrates that the user can select a repair order, on which to run the materials usage calculator, by scanning the identifier 902. When the user scans the repair order identifier, the user can then run the material usage calculator on the scanned repair order identifier. In some embodiments, when the repair order identifier is scanned, the system automatically runs the material usage calculator.

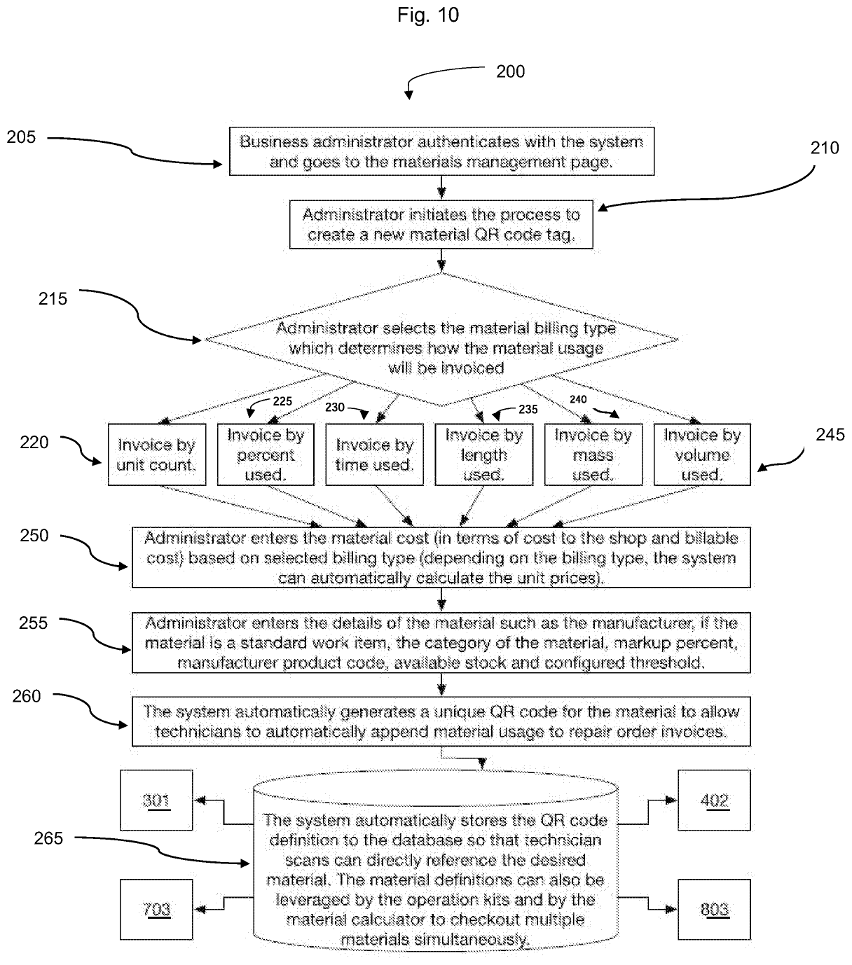

FIG. 10 depicts an embodiment of the system creating a material QR code tag shown in FIG. 8. FIG. 10 is another embodiment of FIG. 3. However, the system as shown in FIG. 10 additionally shows a material, also referred to as a material definition, that has been created within the system. This material definition can be leveraged by the material operation kits and by the material calculator to checkout multiple materials simultaneously 270.

In the system, there are a plurality of materials that exist within the auto body shop or business' inventory. Each material that has a material QR code tag also has a material definition. The plurality of materials is used in creating both material operation kits and material calculator configurations.

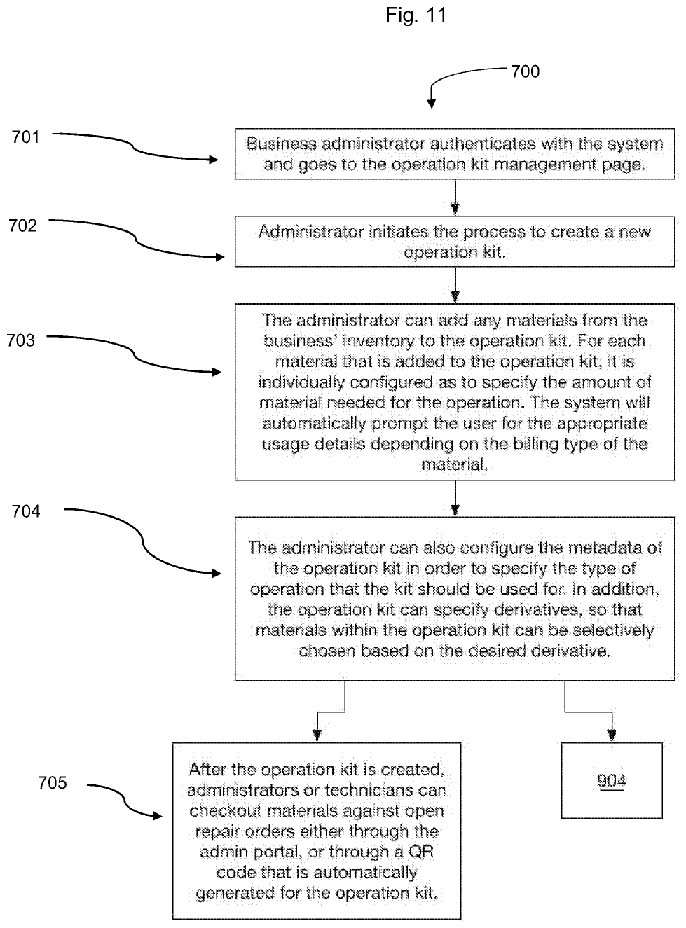

FIG. 11 depicts the system creating a material operation kit. The material operation kit allows the user to quickly create invoices or estimations by simply selecting a custom material operation kit for a particular repair as opposed to individually adding each material to a repair. A material operation kit has all the materials for a particular repair associated with the material operation kit so that the user can select the material operation kit for that repair. To create a material operation kit, the system utilizes a computer and software executing on that computer.

The system allows a business administrator to authenticate with the system and goes to the operation kit management page 701. In some embodiments, the business administrator is a technician. In other embodiments, the business administrator is any user working with the system.

Material operation kit is also referred to as an operation kit or a kit throughout the application.

Administrator initiates the process to create a new operation kit 702. In some embodiments, the system can automatically initiate the process to create a new material operation kit. In other embodiments, a material operation kit is automatically selected upon a customer inputting their information into the system. Instead of a user having to select the material operation kit themselves, the system will select the material operation kit based on the customer's information. The customer's information can include details about the type of car, the make, model, and year of the car, the damage to the car, the extent of damage to car, and what caused the damage to the car. For example, if the customer's information indicated that a bumper would need to be replaced, then the system would pick a corresponding material operation kit that would generate the materials and the costs of the materials for replacing the bumper of that car. A user can then review the material operation kit to ensure that the details of the material operation kit are correct and correctly correspond with the repair required for the customer. In different embodiments, the system retrieves this information from a third-party system integration. In other embodiments, customer information can be used by the system to provide references to previous repair orders that were similar. For example, if new customer information is processed by the system and the extent of damage and what caused the damage are similar to a previous repair order, the system can suggest the user to review the previous repair order to see what repairs were completed on that repair order. The system can additionally recommend which material operations kits to utilize based on referencing these repair orders and the customer information associated with the material operation kits utilized on those repair orders. In some embodiments, the system automatically associates material operation kits with suitable repair orders. Suitable repair orders are ones in which a particular material operation kit matches some or all of the necessary materials required to fulfill the repair order. Fulfilling a repair order means that all the repairs necessary to fix a vehicle up to the customer's requests have been completed. In some embodiments, fulfilling a repair order means that only some parts of the vehicle have been repaired. In other embodiments, fulfilling a repair order means that the entire vehicle has been repaired.

In most embodiments, materials associated with the material operation kit are also associated with the customer's information. When creating a material operation kit, the system uses customer's information to suggest materials for a material operation kit. In some embodiments, the system does this via artificial intelligence, where the system uses the customer's information to automatically add materials and material amounts to a material operation kit. Through this, the system associates customer's information with materials, thus creating and building a database that the system references for future repair orders.

In addition to creating new material operation kits, an existing material operation kit can be modified within the system. For example, if a new material is found to be useful when a repair order with a particular material operation kit is being worked on by a technician, the new material can be added to the material operation kit. Further, if using more of a particular material is found to be useful by a technician, then the amount of the material in the material operation kit can be increased as well. Materials in the material operation kit can be increased, decreased, added, and removed, allowing the system to be both customizable and flexible.

In other embodiments, a plurality of material operation kits is provided by the system. The plurality of material operation kits provided by the system can be modified based on the user's preferences. For example, if the user utilizes more or less of a particular material than the material operation kit suggests, then the user can modify the material in the material operation kit by either decreasing or increasing the amount of material that is set in the material operation kit. This advantageously gives the user the ability to use the provided plurality of material operation kits in ways that suit their auto body shop's preferences.

In different embodiments, the system prompts the user on whether to create a material operation kit based on the customer's information. If the user selects yes, then a material operation kit based on the customer's information is created and can be used for future customers that require similar repair work to be performed.

The administrator can add any materials from the business' inventory to the operation kit. For each material that is added to the operation kit, it is individually configured as to specify the amount of material needed for the operation. The system will automatically prompt the user for the appropriate usage details depending on the billing type of the material 703. Materials and the amount of materials are selected and associated with material operation kits, providing the system with a large amount of opportunities to customize and fine-tune the material operation kits. The customization this provides allows the system to specify the materials and the amounts of materials used in a material operation kit. The material operation kit can then be selected by any future user engaged in a similar repair order. Additionally, the system can also remove materials associated with material operation kits. Further, the system can increase or decrease the amount of materials associated with a material operation kit. Instead of having to select individual materials for a repair order, the user can now select a material operation kit that has all the necessary materials and amount of materials to complete a repair. In most embodiments, material operation kits act as the different types of repairs, methods, and operations that an auto body shop or business performs that can be added to a repair order.

In some embodiments, the materials associated with a material operation kit contains all the materials used on an entire repair order. In these embodiments, a material operation kit incorporates all the materials required to repair the entirety of damages featured in a repair order. This is an advantageous embodiment as the system only has to associate one material operation kit with one repair order as opposed to associating several material operation kits with one repair order.

The administrator can also configure the metadata of the operation kit in order to specify the type of operation that the kit should be used for. In addition, the operation kit can specify derivatives, so that materials within the operation kit can be selectively chosen based on the desired derivative 704. Metadata of the material operation kit is configured by the user of the system and then the system associates that metadata with the material operation kit. The user configured metadata allows the material operation kits to be organized in a manner that the auto body shop or business desires. This organization improves the efficiency of the auto body shop by having specific names for material operation kits that are used for specific repairs. For example, metadata can include the name of the material operation kit. This name can be anything that would indicate to the user what is being repaired, such as “rear bumper replacement.” This metadata can be associated with a material operation kit and increases the organization of an auto body shop that may have a large amount of material operation kits within their system.

After the operation kit is created, administrators or technicians can checkout materials against open repair orders either through the admin portal, or through a QR code that is automatically generated for the operation kit 705. After a material operation kit is created or modified, an identifier is generated for the material operation kit. This identifier, such as QR code, can be scanned by a technician or other individual associated with the auto body shop or business to add the material operation kit to a repair order. In some embodiments, material operation kits are stored within the system for use on similar repair orders that come in the future. By storing the material operation kit in the system, the material operation kit can be automatically recommended for future repair order jobs by the system. The system recognizes, based on customer information, if a material operation kit within the system should be performed on a particular vehicle for a repair order. The system then recommends the particular material operation kit or material operations kits for the repair order. In this way, storing a material operation kit allows the system to utilize the kit whenever it can be utilized for a given repair order. For example, if the system recognizes that the entire front section of a vehicle needs to be completely repainted based on the customer's information, the system can automatically suggest a material operation kit that includes repainting the entire front section of a vehicle. In other embodiments, the material operation kit can be added to a materials calculator. When the material operation kit is added to a materials calculator, it affects the cost detailed in the estimation or invoice that the materials calculator generates.

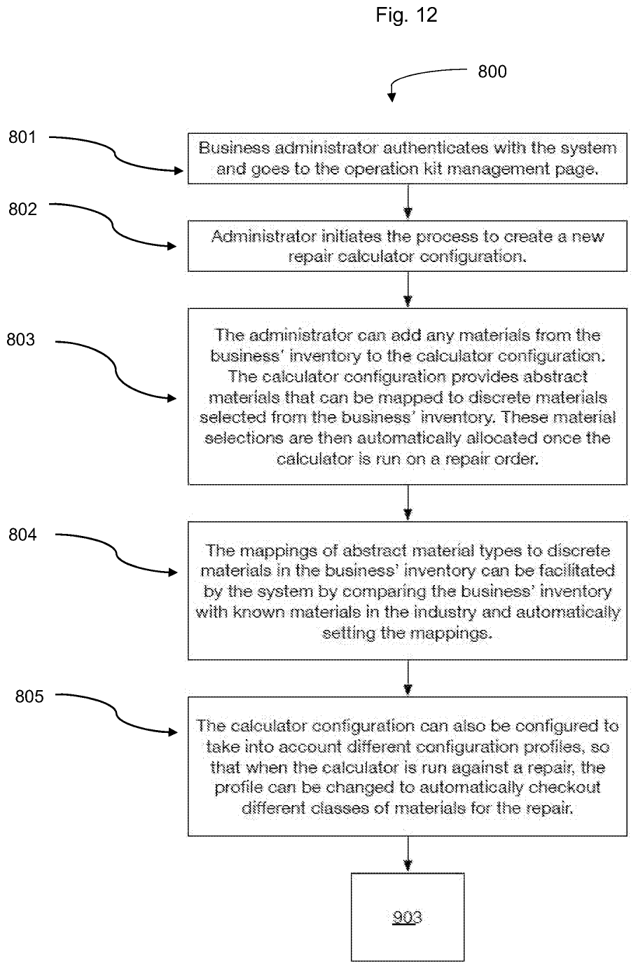

FIG. 12 depicts the system creating a material calculator configuration. The material calculator configuration enables the system to map abstract materials, which are effectively categories of different material types, to discrete materials, which are the tangible materials that exist within the auto body shop. To create a material calculator configuration, the system utilizes a computer and software executing on that computer.

Business administrator authenticates with the system and goes to the operation kit management page 801. In some embodiments, the business administrator is a technician. In other embodiments, the business administrator is any user working with the system. In different embodiments, the system allows the business administrator to interact with the repair calculator configuration at any point while using the system. In some embodiments, a repair calculator configuration is referred to as a materials calculator configuration or a calculator configuration.

Administrator initiates the process to create a new repair calculator configuration 802. In different embodiments, the system automatically prompts the user to create a new repair calculator configuration. In other embodiments, existing repair calculator configurations can be modified.

The administrator can add any materials from the business' inventory to the calculator configuration. The calculator configuration provides abstract materials that can be mapped to discrete materials selected from the business' inventory. These material selections are then automatically allocated once the calculator is run on a repair order 803. The materials from the business' inventory are any of the tangible materials that an auto body shop actually utilizes in their shop. These materials are referred to as discrete materials. A discrete material that an auto body shop utilizes has a manufacturer, item type, measurement unit, and other data that allows the user to find it within the system. Importantly, this allows the system to generate precise estimations and invoices as it utilizes the costs of a discrete material used by the auto body shop as opposed to a generalized price for an abstract material. In some embodiments, the system has a plurality of discrete materials and a plurality of abstract materials that the user can select. This plurality of discrete materials can be modified by the user, where they can add or remove discrete materials from the system. They can also modify the data associated with the discrete materials. The plurality of abstract materials can also be modified by the user, where they can add or remove abstract materials from the system.

Abstract materials are general categories of materials commonly utilized within the auto body shop industry. In some embodiments, users can create new abstract materials within the system. In other embodiments, the system can automatically update with new abstract materials. The general types of abstract materials consist of several categories, including, but not limited to, paint material configurations and refinish material configurations. The paint material configurations consist of several abstract paint materials including, but not limited to, paint manufacturer, paint line, measurement unit, sealer, sealer activator, sealer+activator ratio, clear coat, clear activator, clear+activator ratio, adhesion promotor, flattening agent, base blend/wet-bed, and flex agent. The refinish materials configurations consist of several abstract refinish materials including, but not limited to, very fine scuff pad, ultra fine scuff pad, 400-600 grit DA paper, 800-1000 grit DA paper, ¾″ tape, 1 W-2″ tape, 6″ masking paper, 18″ masking paper, foam tape, 1500 grit DA sheet, 2000 grit DA sheet, 3000 grit DA sheet, 5000 grit DA sheet, 8000 grit DA sheet, cutting compound, polishing compound, booth filter, cutting pad, polishing pad, and disposable liner and lid.

In most embodiments, discrete materials are associated with related abstract materials. In other embodiments, the cost of the material is associated with the discrete material. The cost of each individual material being associated with each material available within the system is useful in that it allows accurate invoices and estimations to be generated. In some embodiments, the costs of each individual material updates in real time, allowing for increased accuracy in invoicing and estimating. The system can retrieve these costs by referencing third-party sources. In other embodiments, new discrete materials can be introduced to the system and these new discrete materials are automatically associated with related abstract materials. For example, if new ultra fine scuff pad A was released onto the market and purchased by an auto body shop, ultra fine scuff pad A would be added to the system and the system would associate it with the ultra fine scuff pad abstract material. The system associates discrete materials in this way by utilizing artificial intelligence, key word recognition software, identifiers, or associated metadata. New discrete materials can be categorized within abstract materials in this manner.

Within each of the several abstract paint materials, there are discrete materials that accurately reflects what materials are available within the auto body shop. For example, within sealer of the abstract paint materials, there is a plurality of sealers. Each of the plurality of sealers represents a discrete material that can be found at the auto-body shop. By allowing a discrete material to be chosen, the system can generate accurate invoices and estimations. The system does this by utilizing the discrete material price when the materials calculator is run. By utilizing the discrete material prices in the materials calculator configuration, the materials calculator can then generate an invoice or estimation that reflects the actual costs of the discrete materials used in repairs on a particular repair order. This is an improvement on many currently available systems as they only use estimations that reflect an abstract material as opposed to a discrete material. These discrete materials, representing tangible materials, are associated with the related abstract paint material within the system.

Within each of the several abstract refinish materials, there are discrete materials that accurately reflects what materials are available within the auto body shop. For example, within ultra fine scuff pad of the abstract refinish materials, there is a plurality of ultra fine scuff pads. Each of the plurality of ultra fine scuff pads represents a discrete material that can be found at the auto-body shop. As with the abstract paint materials, by allowing a discrete material to be chosen for abstract refinish materials, the system can generate accurate invoices and estimations. These discrete materials, representing tangible materials, are associated with the related abstract refinish material within the system.

Both the abstract paint materials and abstract refinish materials act as categories from which a discrete material is selected by the system.

In some embodiments, the system automatically selects the discrete materials for a repair order based on the information listed in the repair order and the materials available in the auto body shop. In other embodiments, the amount of materials in an auto body shop is accurately reflected in the discrete materials detailed within the system. As a result, if a given material was to run out in an auto body shop, the discrete materials in the system would reflect that. For example, if one type of sealer at an auto body shop were to run out, the discrete material within the system for that type of sealer would not be an option for the system to select. In other embodiments, the system allows for the discrete material to be selected, but automatically prompts the user that the auto body shop has run out of that material. This allows the user to select an alternative material.

The mappings of abstract material types to discrete materials in the business' inventory can be facilitated by the system by comparing the business' inventory with known materials in the industry and automatically setting the mappings 804. In some embodiments, the mapping of abstract materials to discrete materials in the business' inventory can occur automatically within the system. When a material of a business' inventory is updated, the system recognizes the material and automatically assigns it to a category of abstract material and to a material configuration.

In other embodiments, the system references databases of materials to associate a material added to the business' inventory. When the system recognizes information and metadata related to a material being added to the business' inventory, the system automatically populates the remaining metadata and information related to the material, including, but not limited to, the abstract material type. The system simultaneously associates the abstract material type to a discrete material within the system. For example, if the system recognizes the manufacturer part number (MPN) of a specific product added to the business' inventory, the system automatically populates the name of the product, the manufacturer of the product, the unit of the product, the cost of the product, the type of product, and any other relevant details about the product. The system simultaneously associates the specific product added to the business' inventory, known in the system as the discrete material, to an abstract material type, such as ultra fine scuff pads.

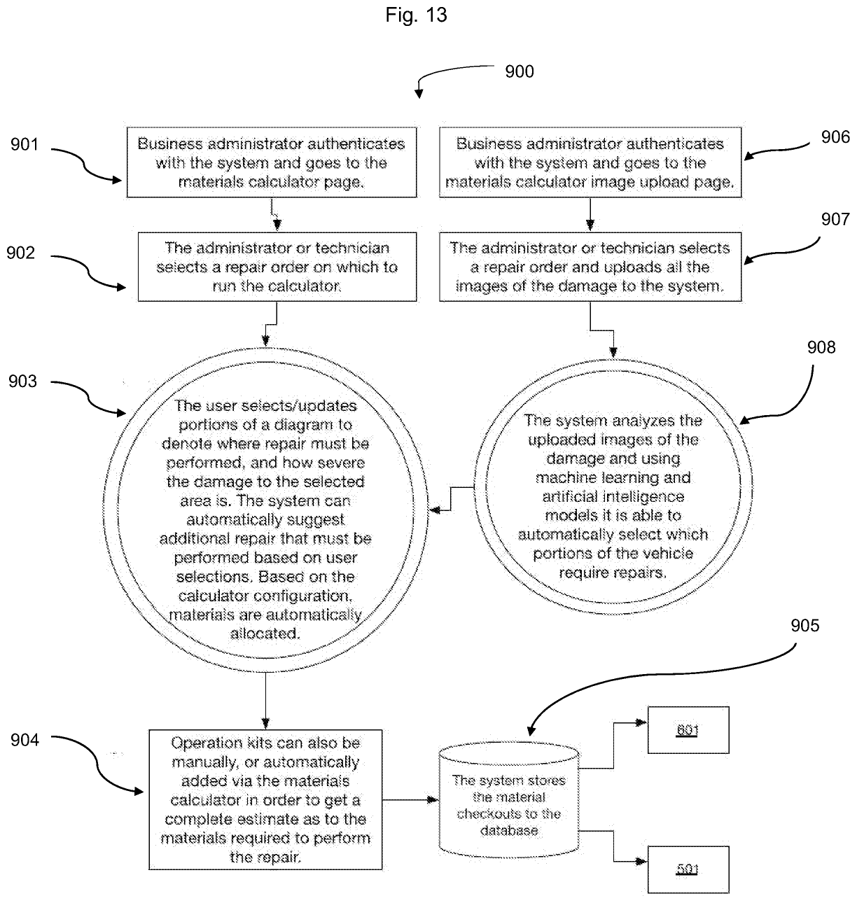

In other embodiments, the costs of the discrete materials are used by the system to generate an estimation or invoice via the materials calculator as illustrated in FIG. 13. Discrete materials are directly associated with the tangible products available for use in an auto body shop or business. The costs of these discrete materials are used in estimations and invoices because these costs must be known, along with how much of the discrete material is used, to calculate the overall cost of the usage of the discrete material for the repairs performed on a repair order. By modifying the materials calculator configuration, the materials calculator and the invoice or estimation that it generates is also modified. The materials calculator configuration and the materials calculator are associated with each other in this way.

The calculator configuration can also be configured to take into account different configuration profiles, so that when the calculator is run against a repair, the profile can be changed to automatically checkout different classes of materials for the repair 805.

FIG. 13 depicts the system generating an estimation or invoice based on the materials used for a repair job on a vehicle. The system utilizes the materials calculator to generate this estimation. To utilize the materials calculator, the system utilizes a computer and software executing on that computer.

Business administrator authenticates with the system and goes to the materials calculator page 901. In some embodiments, based on the user's interactions with the system, the system automatically takes the user to the materials calculator page. In other embodiments, based on the user's interactions with the system, the system prompts the user to go to the materials calculator page.

In addition, the business administrator can authenticate with the system and go to the material calculator image upload page 906. In some embodiments, based on the user's interactions with the system, the system automatically takes the user to the materials calculator image upload page. In other embodiments, based on the user's interactions with the system, the system prompts the user to go to the materials calculator image upload page. This advantageously allows the system to direct a user onto the next aspect of the system that they should work with.

The administrator or technician selects a repair order on which to run the calculator 902. The repair orders are identifiable by metadata associated with that particular repair order within the system. The metadata can include, but is not limited to, the name of the customer, the vehicle make, model, and year, the name of the type of repair needed for the repair order, or a reference number utilized by the particular auto body shop or business. In most embodiments, the repair order is associated with the materials calculator. The repair order is then modified by the materials calculator because the materials calculator determines the extent of damage, specific materials needed to repair that damage, and other relevant criteria.

In addition, the business administrator or technician can select a repair order and upload all the images of the damage to the system 907. The repair orders are identifiable by metadata associated with that particular repair order within the system.

The user selects/updates portions of a diagram to denote where repair must be performed, and how severe the damage to the selected area is. The system can automatically suggest additional repair that must be performed based on user selections. Based on the calculator configuration, materials are automatically allocated 903. The diagram for the panel paint operations is comprised of a plurality of panel components including, but not limited to, driver door, driver door handle, driver fender, driver mirror, driver quarter, driver rocker molding, front bumper, hood, passenger door, passenger door handle, passenger fender, passenger mirror, passenger quarter, passenger rocker molding, rear bumper, roof, and trunk. A refinish level can be selected for each of the plurality of panel components. The refinish level has options that indicate the level of refinish required for each panel component. These options can include, but are not limited to, no work needed, blend, normal repair blend, heavy repair blend, and full refinish. The refinish level option selected for each panel component is indicated on the diagram by a color, where each refinish level option is represented by a different color. In different embodiments, the refinish level option for each panel component is indicated by a number, symbol, or other marking. After these refinish levels are selected, they are associated with the materials calculator and directly affect the costs reflected in the invoice ore estimation. In some embodiments, the system automatically suggests different material operation kits that should be run on the repair order. The specific materials associated with these suggested material operation kits depend on the material calculator configuration associated with the repair order.

The diagram for unibody paint operations is comprised of a plurality of unibody components, including, but not limited to, driver A pillar, driver quarter, driver quarter extension, driver quarter jamb, driver rocker panel, passenger A pillar, passenger quarter, passenger quarter jamb, rear body panel, and roof. A refinish level can be selected for each of the plurality of unibody components. The refinish level has options that indicate the level of refinish required for each unibody component. These options can include, but are not limited to, no work needed, blend, normal repair blend, heavy repair blend, and full refinish. The refinish level option selected for each unibody component is indicated on the diagram by a color, where each refinish level option is represented by a different color. In different embodiments, the refinish level option for each panel component is indicated by a number, symbol, or other marking. After these refinish levels are selected, they are associated with the materials calculator and directly affect the costs reflected in the invoice ore estimation.

The refinish levels options are selected based on how severe the damage to the selected component is. In some embodiments, the system automatically selects the refinish level options utilizing artificial intelligence or using customer information. For example, the system can analyze the uploading images of the damage of the vehicle. Based on this analysis, the system can then select the refinish level options on the diagram for the panel paint operations and the unibody paint operations. In another example, if the customer information indicates that there was significant damage to the bumper of a vehicle, then the system selects the corresponding refinish level to repair the bumper.

After the components are selected, the system can suggest different material operation kits that can be implemented into the materials calculator to fulfill a given repair order. In some embodiments, the system prioritizes different material operation kits based on how significantly they are needed. For example, if a vehicle requires three different material operation kits to be repaired, but only one of these three affects the safety of driving the vehicle, then that material operation kit is prioritized over the other two by the system. This gives the auto body shop the ability to tell the customer which material operation kits should be completed on their repair order first if they cannot pay for all the material operation kits at that point.

When the components and refinish level options are selected, the system can provide cost estimates based on these selections. It can also provide cost estimates and invoices further utilizing accessory paint operations, material operation kits, and hardware.

The system analyzes the uploaded images of the damage and using machine learning and artificial intelligence models it is able to automatically select which portions of the vehicle require repairs 908. Based on the uploaded images, the system determines which panel components and unibody components need to be repaired. It also determines the level of refinish required for each of the panel components and unibody components. In some embodiments, an estimation is automatically generated by the system after the images are uploaded. In other embodiments, the system prompts the user to generate the estimation. This allows the user to review the systems AI's component and refinish selections.

Operation kits can also be manually, or automatically added via the materials calculator in order to get a complete estimate as to the materials required to perform the repair 904. In addition, accessory paint operations can be added via the materials calculator so that these operations can be calculated into the final estimate. Material operation kits can be associated with repair orders. Material operation kits can also be associated with the materials calculator. This allows for maximum flexibility between the variety of components of the system. Each material operation kit that is associated with the materials calculator affects the invoice and estimation generated by the materials calculator. Adding a material operation kit can affect the paint materials cost, the body materials cost, and the hardware cost. Additionally, modifying the materials calculator configuration can also affect the invoice and estimation generated by the materials calculator as the materials calculator configuration is associated with the materials calculator. If a different discrete material is selected, this can decrease or increase the total amount listed on the invoice or estimation. Like with the material operation kit, selecting a new discrete material can affect the paint materials cost, the body materials cost, and the hardware cost. In this way, the materials calculator configuration and the material operation kits are associated and directly affect the estimations and invoices generated by the material calculator.

The system stores the material checkouts to the database 905. The materials that can be checked out include all the materials associated with the operations kits, accessory paint operations, and hardware that are selected. The material checkout is saved along with the billing totals for the paint materials, body materials, and hardware, as well as the total billable amount.

When the materials calculator is active in the system, the repair order for a vehicle, the body type for the vehicle, the paint code for the vehicle, and the refinish stages can be selected. By selecting these options, the materials calculator can be associated with the selections and these selections are reflected in the total costs indicated in an invoice or estimation. For example, when a vehicle body type is selected, the materials calculator is associated with that selection as the materials calculator will depict the vehicle body type with a diagram. If the vehicle body type that is selected is a four door sedan, then the diagram utilized by the materials calculator is a four door sedan. The vehicle diagram that is generated by the materials calculator is useful in that it indicates where the damage occurred as well as the extent of damage. It also acts as a visual aid for any recipient of the invoice or estimation. In some embodiments, the diagram is associated with the materials calculator. In other embodiments, the diagram is not associated with the materials calculator. In further embodiments, the diagram is generated onto the invoice or estimation. In even further embodiments, the diagram is not generated onto the invoice or estimation.

The vehicle body types include, but are not limited to, two-door hatchback/compact, 4-door hatchback, 4 door sedan (large), 4 door sedan (small), convertible, coupe, crossover/small SUV, large SUV, mini van, pickup truck, station wagon, and utility van. The paint code for the vehicle indicates the precise color of paint and the manufacturer of the paint that is used for the vehicle. Refinish stages indicate how many coats of visible paint layers applied one after the other in sequence are needed. Generally, for a two-stage refinish, metallic paint is applied to a primer and then a lacquer layer is applied after that to bring out the shine of the paint as well as sealing and protecting the paint coat. Generally, for a three-stage refinish, a ground coat is first required, then a pearl topcoat, which sometimes requires multiple coats, and then a lacquer layer on top of the pearl topcoat. Most vehicles require refinish stages of up to two or three but some require a four-stage refinish. The level of refinish and the stage of refinish is associated with the materials calculator and these costs are added to the invoice or estimation.

Optionally, the system can indicate whether a flattening agent should be considered or whether two-tone should be considered. A flattening agent is a material added to a coating of paint that causes it to set with a matte surface. A two-tone finish or dual-tone means that one section of the car is a different color than another section of the car. If the system indicates that a flattening agent is needed, then the flattening agent and its costs are associated with the material calculator and its costs are added to the invoice or estimation. If the system indicates that a two-tone finish is needed, then the two-tone finish and its costs are associated with the material calculator and its costs are added to the invoice or estimation.

An example of the materials calculator in the system is as follows. The repair order, body type, paint code, and refinish stages are selected. Optionally, flattening agents or two-tone can be selected as well. The panel components, unibody components, accessory paint operations, material operation kits, and hardware are also selected. Accessory paint operations can include, but are not limited to, brackets, bumper half, hinges, pinch weld/clamp mark, spoiler, spray out cards, and vent/scoop. Material operation kits can include, but are not limited to, 12-hour dent, 12-hour glue pull, 18-hour dent, 2-hour dent, 6-hour dent, A/B pillar replacement, apron replacement, bedside replacement, bumper repair, door skin replacement, floor section replacement, quarter panel replacement, rail replacement, rear body panel replacement, retape molding, rocker panel replacement, rocker undersea! application, roof skin replacement, scratch/chip repair, shell preparation, and structural radiator support replacement. Material operation kits are created and tailored towards the repairs, methods, and operations of a particular auto body shop so the number of potential material operation kits is incredibly large as this feature allows for significant customization. Hardware can include, but is not limited to, 5.6 mm self-piercing rivets, bolts, clips, fasteners, crimp tubes, nuts, pushpin clips, and specialty fasteners. Once all relevant components, paint operations, material operation kits, and hardware are selected, the system then generates an itemized estimation or invoice of the costs for all these selections. The estimation or invoice is then stored in the system. This estimation or invoice can then be provided to third-parties, such as insurance companies, to receive proper compensation for the work done on a repair order by the auto body shop as well as the materials used by the auto body shop for the repair order. In some embodiments, the estimation or invoice is provided to the third-party automatically by the system.

The user or the system can generate the estimation for materials used on a repair order using the material operation kits, the material calculator configuration, and the materials calculator. While utilizing the materials calculator, the system selects the material operation kits needed for that repair order. Additionally, the materials calculator configuration can be utilized to specify the discrete materials used by the material calculator for a repair order. With these discrete materials specified, the materials calculator adds all the costs of the materials associated with the material operation kits that are associated with the repair order. By combining these different aspects of the system, the system can generate precise invoices or estimations.

In most embodiments, the materials calculator utilizes a diagram based on the associated vehicle body type for the repair order. For example, if the vehicle body type that is selected is a four door sedan, the diagram that the materials calculator generates is a four door sedan. As the system selects different refinish levels for the panel components and unibody components, the different refinish levels are shown in the diagram with different colors that indicate the extent of work required to repair/refinish that component. However, some components may only have two refinish levels. For example, door handles only have refinish levels for no work required or full refinish.

Although specific advantages have been enumerated above, various embodiments may include some, none, or all of the enumerated advantages. Other technical advantages may become readily apparent to one of ordinary skill in the art after review of the following figures and description.

1. A system for inputting materials into a billable form comprising:
a computer;
software executing on said computer for providing a kit;
software executing on said computer for associating at least one material with said kit;
software executing on said computer for associating an amount of said at least one material with said kit.

2. A system for scanning materials into a billable form according to claim 1, further comprising:
software executing on said computer for modifying a kit.

3. A system for scanning materials into a billable form according to claim 1, further comprising:
software executing on said computer for associating metadata with said kit.

4. A system for scanning materials into a billable form according to claim 1, further comprising:
software executing on said computer for generating an identifier for said kit.

5. A system for scanning materials into a billable form according to claim 1, wherein said kit contains all the materials used on a repair order.

6. A system for scanning materials into a billable form according to claim 1, further comprising software providing information.

7. A system for scanning materials into a billable form according to claim 6, wherein said at least one material is associated with information.

8. A system for scanning materials into a billable form according to claim 1, further comprising software executing on said computer for storing said kit.

9. A system for inputting materials into a billable form comprising:
a computer;
software executing on said computer for providing at least one material;
software executing on said computer for providing at least one category;
software executing on said computer for associating each of said at least one material with said at least one category;
software executing on said computer for associating a cost of said at least one material with said at least one material;
software executing on said computer for generating an estimation with said costs of said at least one material.

10. A system for inputting materials into a billable form according to claim 9, wherein said at least one material is associated with a manufacturer.

11. A system for inputting materials into a billable form according to claim 9, wherein said at least one material is associated with a product.

12. A system for inputting materials into a billable form according to claim 9, wherein a new material can be added to said at least one category.

13. A system for inputting materials into a billable form according to claim 12, wherein information is extracted from a database and associated with said new material.

14. A system for inputting materials into a billable form according to claim 9, wherein said at least one material is associated with the amount of said product.

15. A system for inputting materials into a billable form according to claim 9, wherein said at least one material is associated with a type.

16. A system for inputting materials into a billable form comprising:
a computer;
software executing on said computer for providing a calculator;
software executing on said computer for associating a repair order with said calculator;
software executing on said computer for associating a kit with said repair order;
software executing on said computer for generating an estimation for said repair order with said calculator and said kit.

17. A system for inputting materials into a billable form according to claim 13, further comprising software executing on said computer for prompting said calculator.

18. A system for inputting materials into a billable form according to claim 13, further comprising software executing on said computer for storing said estimation.

19. A system for inputting materials into a billable form according to claim 13, wherein said calculator is associated with a body type.

20. A system for inputting materials into a billable form according to claim 13, further comprising software executing on said computer for providing said estimation to a third party.
